(19) United States
(12) Patent Application Publication
(10) Pub. No.: US 2017/0212875 A1
(43) Pub. Date: Jul. 27, 2017

(54) PREDICTIVE FILTERING OF CONTENT OF DOCUMENTS

(71) Applicant: Microsoft Technology Licensing, LLC, Redmond, WA (US)

(72) Inventor: Adalberto Foresti, Kirkland, WA (US)

(21) Appl. No.: 15/008,217

(22) Filed: Jan. 27, 2016

(51) Int. Cl. G06F 17/22; G06F 3/0484; G06F 3/0482; G06F 17/30

(52) U.S. Cl. CPC G06F 17/2288; G06F 17/3089; G06F 3/04842; G06F 17/2247; G06F 3/0482

(57) ABSTRACT

A filter system for filtering out content of documents is provided. A filter client receives from a user a selection of content of a first document that the user wants to be obscured when the documents are displayed. The filter client sends to a filter server filter information that includes content information derived from the selected content. The filter client then receives from the filter server a filter generated from filter information sent from the client system and from other client systems of other users. The filter client then obscures content of a second document that matches the filter and then displays the second document.

### BACKGROUND

Many web pages provide content that covers a variety of subjects or topics. For example, a web page of a news website may include an article relating to the United Nations, an article relating to a presidential candidate, an article relating to a weather event (e.g., tornado), a link to an article relating to a company, an image of a traffic accident, and so on. The content of web pages may include text of an article, text and images of an article, standalone images, text of a title, text and images of an advertisement, text and images of a blog, images and image metadata of a photo storage website, video content, animated content, hyperlinks to other web pages, and so on.

Users who view web pages often are not interested in viewing content relating to certain subjects. For example, a fan of the football team of University X may not want to view articles relating to the rival football team of University Y. As another example, a parent may not want their young child to view articles or images relating to violent crimes.

Some websites allow a user to customize web pages by selecting subjects that are of interest to the user. For example, a news website may allow users to select the subjects of local news, national news, international news, business, weather, sports, health, science, technology, and so on. A user who selects local news and sports will be provided with web pages with content only relating to those subjects. Such web pages, however, still may present content that the user may not want to view, such as an article about the football team of University Y or about a recent violent crime.

Some browser extensions allow a user to exclude content from web pages based on keywords supplied by the user. For example, if a football fan specifies a keyword of “University Y,” then a browser extension may remove all articles that mention University Y. So, if the football fan was interested in scientific research being conducted at University Y, any article relating to that research that mentions University Y may be removed from the web pages displayed by the browser. Also, if an article on the football team of University Y referred to the team by the name of its mascot “turkey” and did not include the name University Y, then the browser extension would not remove that article and the football fan would be presented an article about the rival football team.

### SUMMARY

In some examples, a filter system for filtering out content of documents is provided. A filter client receives from a user a selection of content of a first document that the user wants to be obscured when the documents are displayed. The filter client sends to a filter server filter information that includes content information derived from the selected content. The filter client then receives from the filter server a filter generated from filter information sent from the client system and from other client systems of other users. The filter client then obscures content of a second document that matches the filter and then displays the second document.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 illustrates a web page with content that can be selected for filtering out.

FIG. 2 illustrates a web page with content selected in content selection mode.

FIG. 3 illustrates a web page with filtered-out content.

FIG. 4 illustrates a web page with content that should not be filtered out.

FIG. 5 illustrates a web page with content filtered out that should not have been filtered out.

FIG. 6 illustrates a web page with content that has been revealed.

FIG. 7 illustrates a web page with content selected that should not have been filtered out.

FIG. 8 is a block diagram that illustrates the filter system in some examples.

FIG. 9 illustrates information stored in the user filter storage for each user in some examples.

FIG. 10 illustrates different filters with the same filter name.

FIG. 11 is a flow diagram that illustrates the processing of a receive filter request component of a filter client in some examples.

FIG. 12 is a flow diagram that illustrates the processing of a receive exception request component of a filter client in some examples.

FIG. 13 is a flow diagram that illustrates the processing of a filter document component of a filter client in some examples.

FIG. 14 is a flow diagram that illustrates the processing of an apply filter component of a filter client in some examples.

FIG. 15 is a flow diagram that illustrates the processing of a receive new filter component of a filter server in some examples.

FIG. 16 is a flow diagram that illustrates the processing of a receive exception component of a filter server in some examples.

FIG. 17 is a flow diagram that illustrates the processing of a generate filters component of a filter server in some examples.

FIG. 18 is a flow diagram that illustrates the processing of a generate exceptions component of a filter server in some examples.

FIG. 19 is a flow diagram that illustrates the processing of a distribute component of a filter server in some examples.

### DETAILED DESCRIPTION

A method and system for filtering content of a web page is provided. In some examples, a filter system includes a filter client and a filter server. The filter client allows users to select content of web pages that users want filtered out. For example, a fan of the football team of University X may select from a currently displayed web page an article about the rival football team of University Y. The filter system filters out content of other web pages that are similar to the selected article. The filter client may request the users to provide a description or name, referred to as a “filter name,” for the type of content that is to be filtered out of web pages. For example, the fan may provide the name of University Y or the name of the university's mascot “turkey.” The filter client sends to the filter server filter information that includes the filter name if any and the filter information derived from the selected content. For example, the filter information may include content information and metadata information. The content information may include all the text and images of the selected content or may include a feature vector of selected features of the selected content such as keywords of the text, frequency of the keywords, and so on. The metadata information may include a uniform resource identifier (“URI”) of the web page, author name associated with the content, title of an article, and so on.

In some examples, upon receiving the filter information from the users, the filter server generates a filter designed to identify content of web pages that is similar to content selected by the users. For example, the filter server may generate a filter with the filter name of “University Y” based on all the filter information provided by users who named their filters “University Y.” As another example, the filter server may generate a filter based on filter information with the same or similar filter information (e.g., based on a similarity score) regardless of the names given to the filters by the various users. In such a case, the name of the filter may be ignored or treated as metadata information when generating the filter, but the filter name provided by each user would be used to identify the filter to that user. A filter may be represented as a feature vector of keywords and metadata information derived from the filter information that is based on content selected by the users. For example, the feature vector may include content features and metadata features. The metadata features may include a URI feature that represents types of websites or sections of websites on which the selected content was found such as sports, science, health, and so on. The content features may include keyword features such as the keyword “University Y” and the keyword “turkey.” Each of the features may also have an associated feature weight indicating importance of the feature to the filter. For example, the keyword feature for “turkey,” the mascot of University Y, may have a higher weight than the keyword feature for “University Y” if all the content selected by users for the “turkey” filter included the mascot name, but not all the content included “University Y.” The filter server then distributes the filter to the filter clients of users whose filter information was used to generate the filter.

In some examples, when a filter client receives a filter, it stores the filter for use when filtering content of web pages that match the filter. When a user retrieves a web page, the filter client applies the filter to the content of the web page. For example, the client may use the document object model (“DOM”) hierarchy of the web page to identify the individual content (e.g., articles, images, and blog postings). For each identified content, the filter client may create a feature vector. For example, the feature vector for an article may include the type of the web page, the keywords of the article, the author of the article, and so on. As another example, the feature vector for an image may include the URI of the image, a histogram of the image, keywords from a caption for the image, and so on. The filter client may generate a similarity score, for example, by applying a cosine similarity function to the filter feature vector and the content feature vector. If the filter includes weights for the features, the similarity score may be based on those weights. If the similarity score (e.g., between 0 and 1) exceeds a similarity threshold (e.g., 0.9), then the filter client marks the content to be filtered out when the web page is displayed.

In some examples, the filter client filters out content by obscuring the content in some way. For example, the filter client may obscure the content by replacing the content with blank content in the DOM hierarchy of the web page. As another example, the filter client may remove the content completely from the DOM hierarchy and reorganize the hierarchy so that a user would be unaware that the content was removed. As yet another example, the filter client may leave the content in the DOM hierarchy but distort the content in some way so that, for example, text or images are so distorted as to be unrecognizable.

Because the filter server generates a filter based on filter information received from multiple users, the filter may be able to filter out content that is similar to the content selected by a user but that contains very different keywords. In a sense, the filter system predicts what content a user wants to filter out based on content that other users want filtered out. For example, a user who selected content for the filter with the word “turkey” may have selected content that included the mascot name “turkey” and the word “football,” but did not include “University Y.” Other users may have selected content that included “University Y, but did not include the mascot name or the word “football.” The filter generated by the filter server, however, may include keywords such as “turkey,” “University Y,” “football,” “touchdown,” the football league name, and so on. As a result, content that does not mention University Y may be filtered out for a user even though a user only selected content that specifically mentioned University Y. In this way, the filter system leverages the filter information of many users to provide predictive filtering for users who use the same filter.

In some examples, the filter server may factor in the popularity of a web page that contains the content from which the filter information is derived when generating a filter. For example, if the web page is very popular, then the filter server may decide to regenerate an existing filter that relates to that content based on the content. If, however, the web page is not popular, then the filter server may decide not to regenerate the existing filter. In this way, the filter server can avoid having to regenerate filter based on content that the vast majority of users are unlikely to access because the content is on an unpopular web page. Eventually, if the filter server regenerates the existing filter, the filter server can then factor in the content of the unpopular web page.

The filter server may base the popularity of a web page on a web page ranking algorithm such as PageRank, which is based on the principle that web pages will have links to (i.e., “out links”) important web pages. The importance of a web page is based on the number and importance of other web pages that link to that web page (i.e., “in links”). PageRank is based on a random surfer model of visiting web pages of a web graph (vertices representing web pages and links representing hyperlinks) and represents the importance of a web page as the stationary probability of visiting that web page. In the random surfer model, a surfer visiting a current page will visit a next page by randomly selecting a link of the current web page or by randomly jumping to any web page. If the current web page has three out links to target web pages, then the transition probability of visiting each target web page from the current web page is ⅓ using a link of the current web page. The probability of jumping to any web page is typically set to equal the probability of jumping to any other web page. So, if there are n web pages, then the jumping probability is set to 1/n for each web page, referred to as a jumping vector. PageRank is thus based on a Markov random walk that only depends on the information (e.g., hyperlinks) of the current web page and the jumping probabilities.

In some examples, the filter server may apply various algorithms to identify additional matching content of web pages that are considered to match a filter. After generating a filter feature vector based on filter information, the filter server may search for web pages with content that matches the filter and augment the filter feature vector with unique content identifiers such as the uniform resource identifiers (“URI”) of the content. The filter server may use content collected by a web crawler to identify web pages, images, videos, and so on that match the filter. For example, if the filter relates to “University Y,” the filter server may identify web pages that include the name of the president of the university, images of the football stadium of the university, and videos of football games of the university and augment the filter with the URIs of the content. When a filter client filters a web page that includes a reference to one of the URIs, the filter client may disable and obscure that reference. For example, if the reference is a link to a web page, then the filter client may remove the link before displaying the web page. As another example, if the reference is to an image to be displayed as part of the web page, the filter client may suppress the retrieving of the images or obscure that image when displayed. Because the filter server would typically have much more computational power (e.g., provided by hundreds of computers) than an individual filter client, the filter server can identify additional content that could not practically be identified by a filter client. Thus, a filter client can efficiently filter some content based on the filter feature vector and the additional content based on the identified URIs. In addition, even if the filter information used to generate a filter is sparse, the augmenting of the URIs to provide more effective filter.

In some examples, the filter server may use semantic mapping techniques to identify the additional matching content. A semantic mapping technique may be based on a semantic data model, referred to as the Resource Description Framework (“RDF”), that has been developed by the World Wide Web Consortium (“W3C”) to model web resources. For example, a semantic data model may indicate that “John Doe is employee of University Y,” that “John Doe is coach of football,” and that “www.imagerepository.org/image.jpg is image of John Doe.” In such a case, the filter server would identify as additional mapping content web pages that mention John Doe and the image referenced by www.imagerepository.org/image.jpg. The semantic mapping technique may identify that the image is of John Doe based on metadata associated with the image or content on web pages that include a reference to that image.

In some examples, the filter server may generate a rating or reputation for users based on implicit or explicit actions of other users. The filter server may track various interactions of users with the filter system such as each contribution of a user to a certain filter (e.g., new filter information to refine the filter exception information for the filter). If a user submits significant filter exception information for a filter, the filter server may take that as an indication that the filter did not accurately reflect what the user expected. In such a case, the filter server may give the users who submitted filter information for the filter (or the filter itself) a low rating from the point of view of that user. The filter system may also allow users to explicitly rate filters or users. For example, some users may give a low rating to a filter that filters out content relating to University Y because those users may only want to exclude content that criticizes University Y. As another example, the filter system may allow users to rate other users by displaying information describing filters to which a user contributed. The information may also include explanations of users as to why they contributed filter information to a filter. For example, a user may explain that content relating to house cats should be excluding from a filter relating to wild animals or from a filter relating to pets. The users can then rate that user based on whether they think the filters accurately filter content as represented by the user. For example, a user may have contributed information to exclude cats from a pet filter, which most users may find unreasonable. In contrast, most users may find the exclusion of cats from a wild animal filter to be reasonable. As such, that user may be given a high or low rating depending on the filter to which that user contributes. When generating a filter for a user, the filter server may weigh the contribution of users who are rated highly by the user more than the contribution of users who are not rated highly by the user.

The filter server may use collaborative filtering techniques to generate filters of users who exhibit similar rating profiles. A rating profile may be based on ratings users give to filters and to other users and on ratings other users give to them. For example, the filter server may generate cluster of users with similar rating profiles and then generate filters for each cluster based on filter information provided by the users in a cluster. In addition, the filter server may recommend to a user filters used by other users in the same cluster. The filter server may also use other factors when generating clusters of similar users such as political affiliation, religious affiliation, education level, age, citizenship, residency, and so on.

In some embodiments, the filter server may combine filters that are similar and provide users of those filters with the combined filters. For example, a group of users may use a filter relating to cats and another group of users may user a filter relating to feline. Originally, the cat filter may have related only to house cats, but over time the additional filter information submitted by users of the filter may have resulted in the exclusion of cats of all type. As such, the cat filter and the feline filter may have evolved to be very similar. In such a case, the filter server generates a combined filter to be used in place of the cat filter and feline filter.

In some examples, the filter system may allow a user to specify content that should have been filtered out or that should not have been filtered out. When a user views content that should have been filtered out by a filter, the filter client allows the user to select the content and the filter (e.g., by filter name) that the selected content should have matched. The filter client then sends to the filter server filter information that includes the filter name and content information derived from the selected content. The filter server can then use the filter information to modify the filter accordingly such as by changing the weight of certain features or modifying features.

The identification of content that should not have been filtered out is somewhat more difficult as the user cannot recognize content that has been obscured. To assist a user in identifying such content, the filter client may provide an unfiltered mode in which a web page is displayed without filtering or in which the filtered-out content is displayed in a separate window. If the content should not have been filtered out, the filter client allows the user to select the content and indicate that it should not have been filtered out. In response, the filter client sends to the filter server exception information that may include the filter name of the filter that caused the selected content to be filtered out and content information derived from the selected content that should not have been filtered out. The filter server can then use the filter information to modify the filter accordingly such as by changing the weight of certain features.

In some examples, the filter system may allow users to select filters to be downloaded and installed by their filter clients. For example, the filter system may provide a web page that provides a list of available filters and a description of each filter. The filters on the list may be generated based on content selected by multiple users or generated manually. For example, another football fan who wants to filter out articles on the University Y football team may select the filter name “turkey.” As another example, a company may want to prevent its employees of a product design team from viewing content about a competitor's product so that design team is not influence by the competitor's product. So, the company may manually create a filter to filter out the content relating to the competitor's product. The company could also select examples of content relating to the competitor's product so that the filter system will automatically generate a filter. In either case, the filter for the content can be included in the list for downloading and installing by the filter clients of employees on the design team. The company may also direct that the filter be automatically downloaded and installed on the company's computing devices to prevent employees on the design team from viewing the content.

The filter system solves various technical problems. For example, the filter system leverages the filter information collected from multiple users for the same filter to predict what content a user may want to filter out even though that content uses very different wording. As another example, the filter system offloads the generating of the filters to the filter server to take advantage of more computing power (e.g., provided by a data center of servers) than can be provided by a user's computing system. As another example, the filter server provides a mechanism for refining filters by providing additional filter information and/or exception information for a filter. As another example, the filter server provides for simplified selection of content that is to be filtered out or that should not have been filtered out.

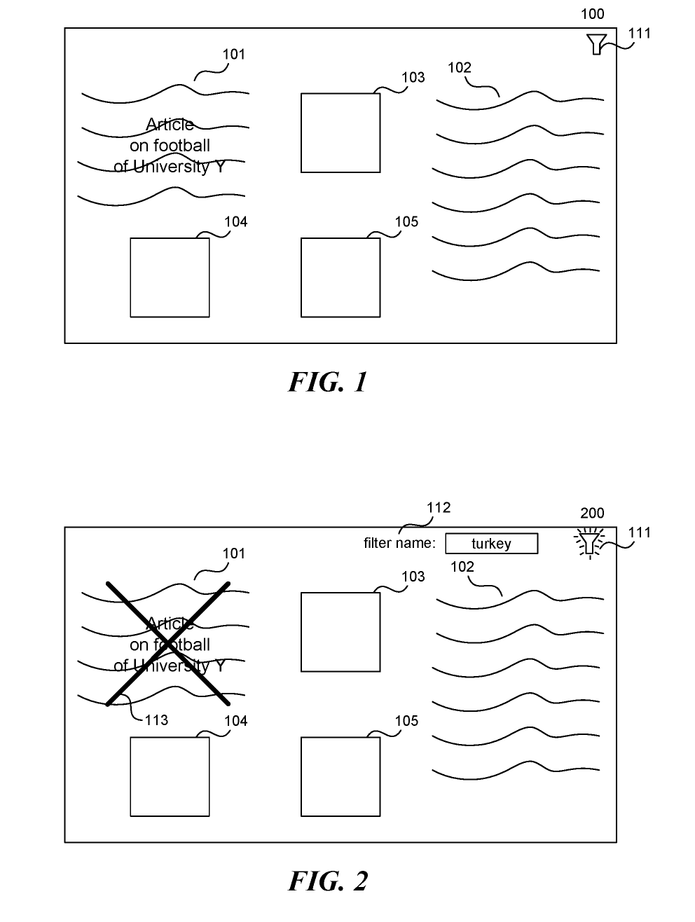

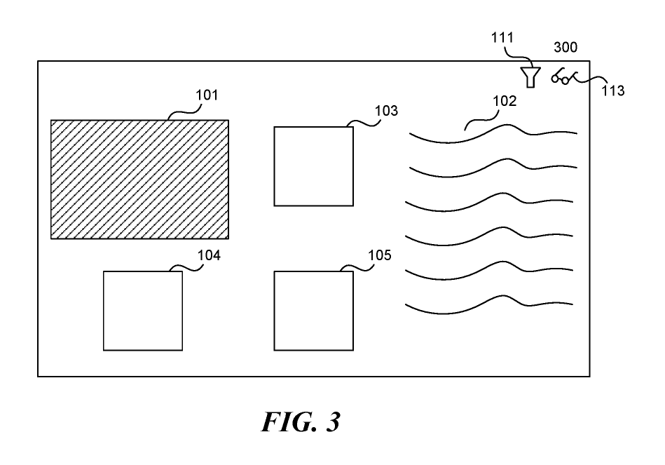

FIGS. 1-7 illustrate the filtering of content from web pages in some examples. The wavy lines in the figures represent text. FIG. 1 illustrates a web page with content that can be selected for filtering out. A web page 100 includes text content 101 and 102 and image content 103-105. The web page also includes a filter icon 111, which may be added to a tool bar of a web browser. When the filter icon 111 is selected, the filter client enters a content selection mode. FIG. 2 illustrates a web page with content selected in content selection mode. A web page 200 includes the same content as web page 100 but also includes highlighted filter icon 111, a filter name input field 112, and a filter selection symbol 113. The web page 200 is displayed after the user selects the filter icon 111 of web page 100. The filter icon 111 of web page 200 is highlighted to indicate that it has been selected. The web page 200 illustrates that the user then drew the filter selection symbol 113 (e.g., “X”) over the text content 101 to select the text content for the filter. The content may be selected in various ways such as by dragging the cursor over the content, drawing a circle around the text, and so on. The web page 200 also indicates that the user entered a filter name in the filter name input field 112. In this example, since the text content 101 was an article on the football team of University Y, the user entered the mascot's name in the filter name input field. FIG. 3 illustrates a web page with filtered-out content. After the user entered the filter name into the filter name input field 112, the filter client sent the filter information that included the filter name and content information to the filter server and also obscured the selected content. A web page 300 shows that the selected content has been obscured by removal and replacement with lines indicating that the content has been removed. The web page 300 also includes the filter icon 111 and a reveal icon 113. The user can select the filter icon 111 for selecting additional content to be filtered out for the same filter or a different filter. When the user selects the reveal icon 113, the filter client displays any filtered-out content of the web page.

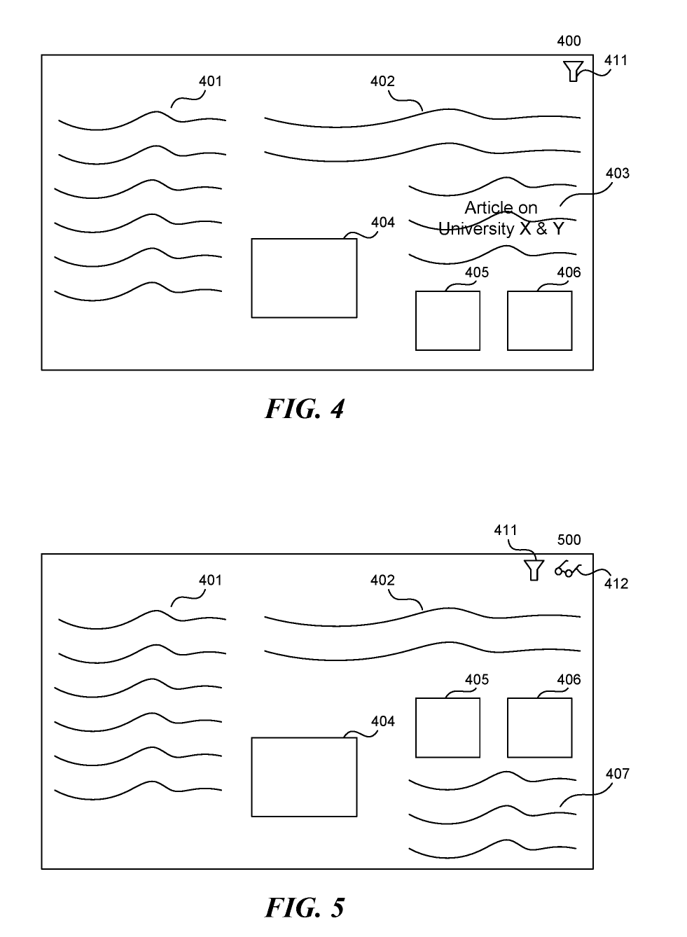

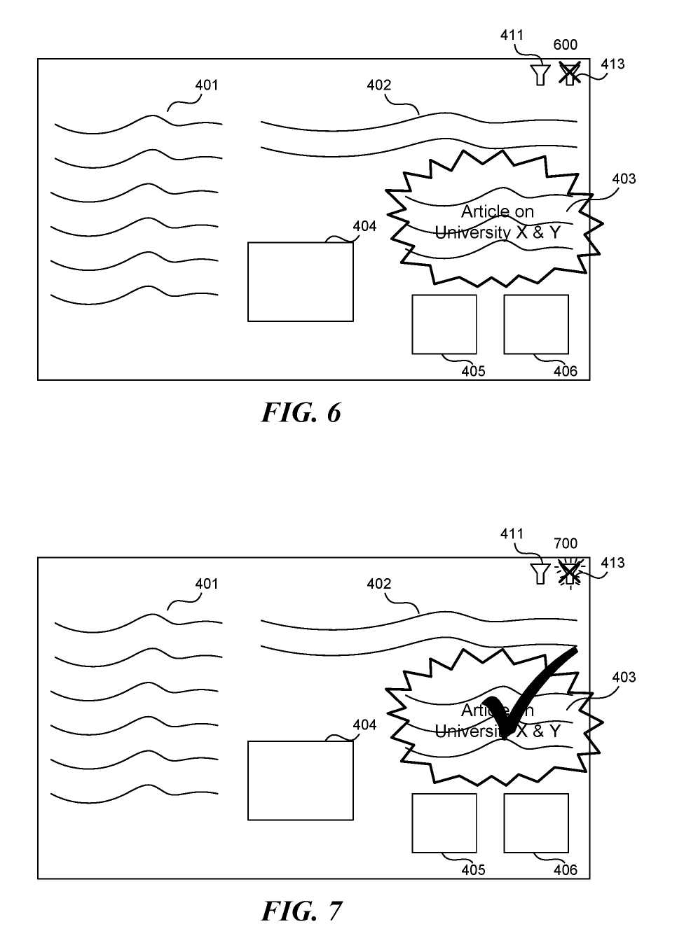

FIG. 4 illustrates a web page with content that should not be filtered out. In this example, content relating to University X and University Y is filtered out because of the filter named “turkey,” but the user does not want any content relating to University X filtered out. A web page 400 includes text content 401-403 and image content 404-406. The web page 400 also includes a filter icon 411. Text content 403 is an article about University X and University Y. FIG. 5 illustrates a web page with content filtered out that should not have been filtered out. A web page 500 shows that text content 403 was filtered out. In this case, the content was filtered out by removing the content from the web page and reorganizing the web page. The reorganized web page includes text content 401 and 402 and image content 404-406. In addition, web page 500 also includes new text content 407. The web page 500 also displays the filter icon 411 and a reveal icon 412. FIG. 6 illustrates a web page with content that has been revealed. A web page 600 includes text content 401-403 and image content 404-406. The filtered-out text content 403 is now revealed because of the user's selection of the reveal icon 412 on the web page 500. Text content 404 may also be highlighted to indicate that it is the content that has been revealed. The web page 600 also includes an exception icon 413 to allow a user to specify an exception to the filter. FIG. 7 illustrates a web page with content selected that should not have been filtered out. A web page 700 includes text content 401-403 and image content 404-406. The web page 700 also includes the filter icon 411 and exception icon 413. The exception icon 413 is highlighted to indicate that it has been selected. The web page 700 also shows that a user has drawn a selection symbol for an exception over content 403 to indicate that it is the content for the exception. Alternatively, the filter client may after a reveal and selection of the exception icon 413 automatically select the revealed content without additional user interaction. After the user specifies the exception to the filter, the filter client sends exception information to the filter server. The filter server may then adjust the filter so that content 403 is no longer filtered out. In such a case, when the web page is next accessed, web page 400 would be displayed, rather than web page 500.

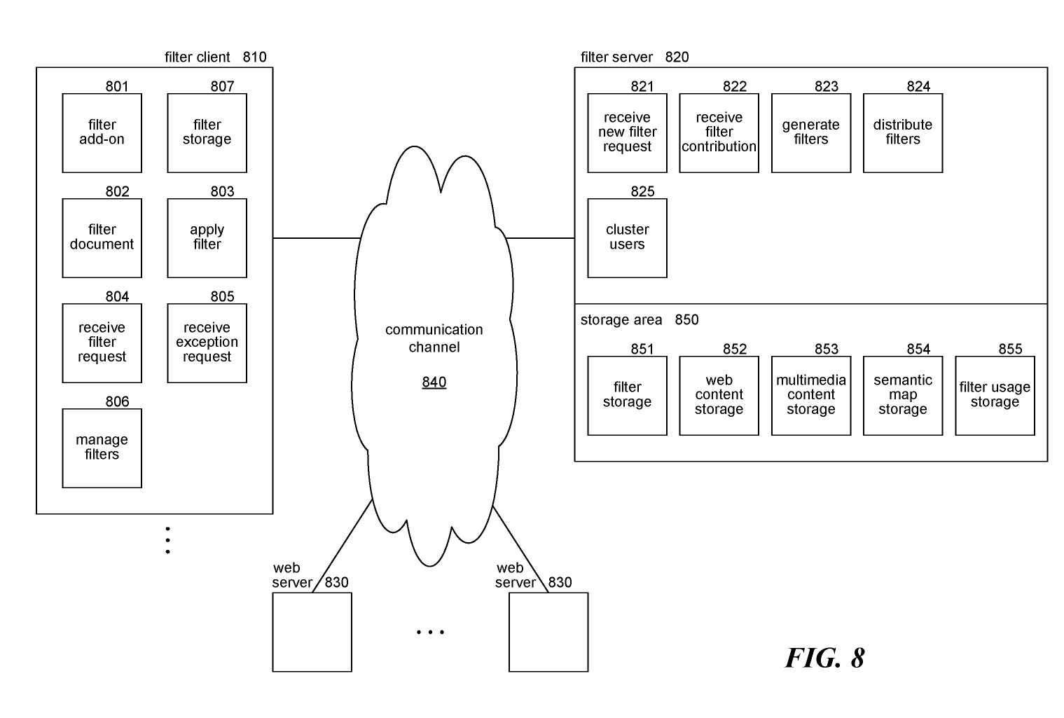

FIG. 8 is a block diagram that illustrates the filter system in some examples. The filter system includes a filter client 810 and a filter server 820. As used herein, the term filter server refers to the combination of a server and server-side code of the filter system, and the term filter client refers to the combination of a client (e.g., device) and client-side code of the filter system. The filter client, filter server, and web servers 830 are connected via a communication channel 840 (e.g., the Internet). The filter client 810 includes a filter add-on 801, a filter document component 802, an apply filter component 803, a receive filter request component 804, a receive exception request component 805, a manage filters component 806, and a filter storage 807. The filter add-on controls the overall filtering process and may be an add-on to a conventional web browser. The filter document component is invoked to filter a document such as a web page. The apply filter component is invoked by the filter document component for each of the filters installed on the filter client. The receive filter request component receives from a user the selection of content for a filter and sends the filter information to the filter server. The receive exception request component receives the selection of content that should be excluded from a filter and sends the exception information to the filter server. The manage filters component allows a user to select the filters to be installed, uninstalled, enabled, and disabled. The filter storage stores the filters that have been installed on the filter client.

The filter server 820 includes a receive new filter request component 821, a receive filter contribution component 822, a generate filters component 823, a distribute filters component 824, a cluster users component 825, and a storage area 850. The storage area includes a filter storage 851, a web content storage 852, a multimedia content storage 853, a semantic map storage 854, and a filter usage storage 855. The receive new filter request component receives filter information from the filter client and stores the filter information in the user storage mapped to the user who provides the filter information. The receive new filter request component may generate a new filter or identify a similar existing filter. The receive filter contribution component receives additional filter information or exception information from the filter client and stores the information in the filter storage mapped to the user who provides the information. The generate filters component generates filters based on the filter information and the exception information of the filter storage, web content storage, multimedia content storage, semantic map storage, and filter usage storage. The filter system may regenerate filters, for example, on a periodic basis (e.g., daily) or when some other condition is satisfied (e.g., percentage change in the number of filters specified by users). The distribute filters component distributes filters of the filter storage to the filter client. The filter storage stores, for each user, filter information and exception information provided by that user and filters provided to the user. The web content storage and the multimedia content storage store information collected by a web crawler as it crawls the web. For example, the information may include URIs of content, keywords of content, metadata of content, and so on. The semantic map storage may contain semantic information in the form of triples consisting of a subject, predicate, and object as specified by RDF. The semantic map may be used to augment filters and exceptions to filters. For example, if content selected by a user includes the words “football,” “score,” and “turkey,” the semantic map may be used to identify “touchdown” as a score for football and may identify that a turkey is the mascot of the football team of University Y. The semantic map may also provide a categorization of a website and sub-website by mapping URIs of web pages to their categories (e.g., sports or news). The categories may be identified by a web crawler as it crawls the web. The filter server may include the category of a web page as a feature. The filter usage storage stores information describing users interactions with filters such filter rating, user ratings, and so on.

The computing systems on which the filter system may be implemented may include a central processing unit, input devices, output devices (e.g., display devices and speakers), storage devices (e.g., memory and disk drives), network interfaces, graphics processing units, accelerometers, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems of filter clients may include desktop computers, laptops, tablets, e-readers, personal digital assistants, smartphones, gaming devices, servers, and so on. The computing systems of filter servers and filter clients may include servers of a data center, massively parallel systems, and so on. The computing systems may access computer-readable media that include computer-readable storage media and data transmission media. The storage media, including computer-readable storage media, are tangible storage means that do not include a transitory, propagating signal. Examples of computer-readable storage media include memory such as primary memory, cache memory, and secondary memory (e.g., DVD) and other storage. The computer-readable storage media may have recorded on them or may be encoded with computer-executable instructions or logic that implements the filter system. The data transmission media are used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys.

The filter system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various examples. Aspects of the filter system may be implemented in hardware using, for example, an application-specific integrated circuit (ASIC).

In some examples, the filter system may be implemented uses hundreds or thousands of filter servers. The filter servers may be implemented using a mapreduce programming model. With the mapreduce programming model, the storage of the contributions of user is distributed across the filter servers so that each filter server locally stores a subset of the contributions. To generate filters, each filter server may cluster its locally stored contributions (e.g., content feature vectors). Each filter server then provides a representative feature vector for each cluster to a filter server controller. The filter server controller then may cluster the representative feature vectors and assign each cluster to a filter server. The filter server controller then may instruct the filter servers to transfer their contributions to the filter servers based on the cluster assignment. Each filter server can then generate filters based on the contributions now locally stored at that filter server.

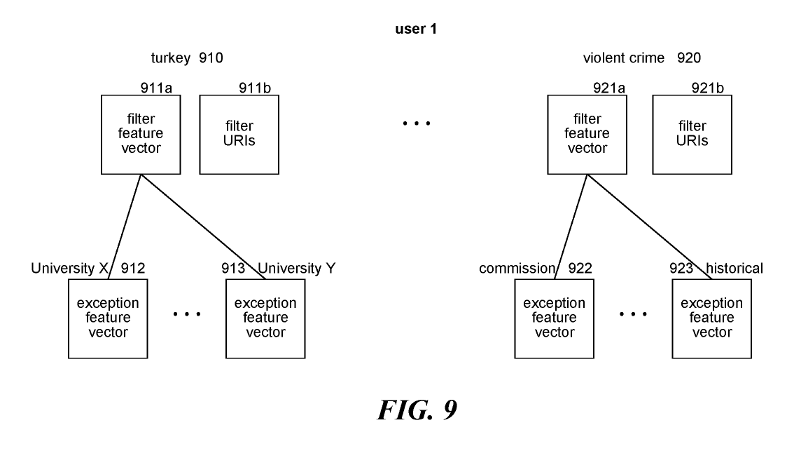

FIG. 9 illustrates information stored in the user filter storage for each user in some examples. A user may have requested various filters. For each filter requested by a user, the filter server stores a user filter that includes a filter feature vector and filter URIs and may store exception feature vectors and exception URI. The filter server augments the filters with filter URIs and exceptions with exception URIs. A filter feature vector for a filter is created based on filter information derived from content selected by the user for a filter. An exception feature vector for a filter is created based on exception information selected by the user for an exception to a filter. The feature vectors may include a filter name feature, URI feature, keyword features, metadata features, and so on derived from the content selected for the filter or the exception. User filters 910 and 920 are for the same user. The user filter 910 is for the filter with the name “turkey” and includes a filter feature vector 911a and filter URIs 911b and exception feature vectors 912-913 for University X and University Y. The user filter 920 is for the filter with the name “violent crime” and includes a filter feature vector 921a and filter URIs 921b and exception feature vectors 922-923 for a commission on violent crime and historical violent crimes.

Users who select very different content for a filter may use the same name for their filters. For example, a user who does not want to see content relating to the football team of University Y may name their filter “turkey,” which may be the university's mascot, while another user who is a vegan who does want to see content relating to turkey farming may also name their filter “turkey.” In some examples, the filter system may employ a clustering technique to cluster filters that appear to be directed to the same type of content using the filter feature vectors. The filter system may only cluster filters together that have the same name. In some examples, the filter system may consider the filter name as a feature that is only one of the many features used when clustering so that a cluster may be based on filters with different names. The filter server may track the users whose filter information contributed to each cluster. For example, the filter system may map users who provided filter information relating the football team to the “turkey” filter for the football team and map users who provided filter information relating turkey farming to the “turkey” filter for turkey farming. The filter server distributes the “turkey” filters to the users based on the mapping. If a user provided filter information related to both the football team and turkey farming, then the filter server may send both “turkey” filters to that user.

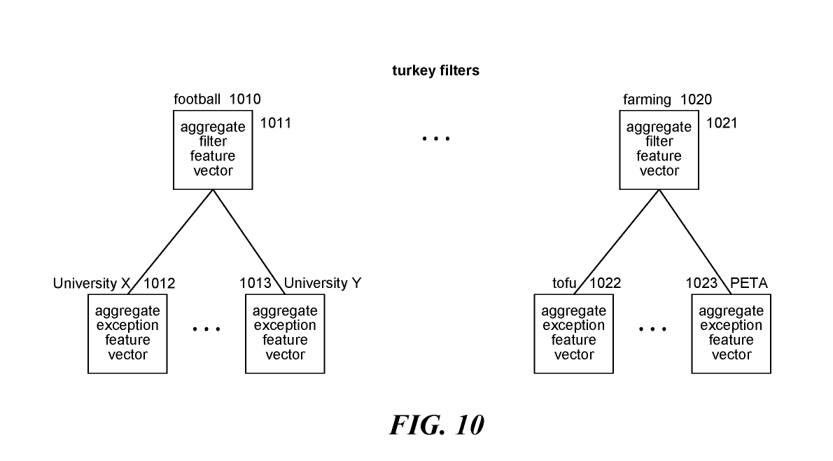

FIG. 10 illustrates different filters with the same filter name. In some examples, after the filters are clustered separately for each filter name, the filter server may also cluster the exceptions associated with each cluster. For example, the filter for the football team with the mascot “turkey” may have an exception cluster for exceptions related to University Y but not related to football and another exception cluster for exceptions related to the football team of University X. As another example, the filter for turkey farming may include an exception cluster for exceptions relating to turkey-flavored tofu and another exception cluster for exceptions relating to the ethical treatment of animals. Filter 1010 represents a filter for the football team and includes an aggregate filter feature vector 1011, an aggregate exception feature vector 1012 for University X, and an aggregate exception feature vector 1013 for University Y. Filter 1020 represents a filter for turkey farming and includes an aggregate filter feature vector 1021, an aggregate exception feature vector 1022 for tofu, and an aggregate exception feature vector 1023 for the ethical treatment of turkeys.

In some examples, the filter system may use various machine learning techniques, such as a support vector machine, a Bayesian network, learning regression, and a neural network, when generating filters. For example, after clustering the user filters, the filter system may employ a support vector machine to train a classifier for each exception cluster for that filter cluster. To train a classifier for an exception cluster, the filter system may use the exception information of that exception cluster as positive examples and the exception information for the other exception clusters of the same filter cluster as negative examples. The filter system may also employ a support vector machine to train a classifier for each filter cluster for a filter name. For example, the filter system may generate an overall aggregate filter feature vector based on all content that users have associated with a “turkey” filter. The filter system may train a classifier for the football filter using the filter information for the football cluster as positive examples and all the other filter information for the “turkey” filter as negative examples. The filter server may then distribute the classifiers to filter clients based on the mapping of users to filters and exceptions.

A support vector machine operates by finding a hypersurface in the space of possible inputs. The hypersurface attempts to split the positive examples (e.g., football filter information) from the negative examples (e.g., non-football filter information) by maximizing the distance between the nearest of the positive and negative examples and the hypersurface. A support vector machine simultaneously minimizes an empirical classification error and maximizes a geometric margin. This allows for correct classification of data that is similar to but not identical to the training data. Various techniques can be used to train a support vector machine. One technique uses a sequential minimal optimization algorithm that breaks the large quadratic programming problem down into a series of small quadratic programming problems that can be solved analytically. (See, “Sequential Minimal Optimization,” http://research.microsoft.com/pubs/69644/tr-98-14.pdf.)

A support vector machine is provided training data represented by (xᵢ,yᵢ) where xᵢ represents a feature vector and yᵢ represents a label for page i. A support vector machine may be used to optimize the following:

$${min}_{w , b , t} \frac{1}{2} {w}^{T} w + C {\sum }_{i = 1}^{l} {ξ}_{i}$$

such that yᵢ(w^{T}φ(xᵢ)+b)≧1−ξᵢ, ξᵢ≧0

where vector w is perpendicular to the separating hypersurface, the offset variable b is used to increase the margin, the slack variable εᵢ represents the degree of misclassification of xᵢ, the function φ maps the vectors xᵢ into a higher dimensional space, and C represents a penalty parameter of the error term. A support vector machine supports linear classification but can be adapted to perform non-linear classification by modifying the kernel function as represented by the following:

(K(xᵢ,xⱼ)≡φ(xᵢ)^{T}(xⱼ))

In some examples, the filter system uses a radial basis function (“RBF”) kernel as represented by the following:

K(xᵢ,xⱼ)=exp(−y∥xᵢ−xⱼ∥²), y>0

The filter system may also use a polynomial Gaussian RBF, or a sigmoid kernel. The filter system may use cross-validation and grid search to find optimal values for parameters y and C. (See Hsu, C. W., Chang, C. C., and Lin, C. J., “A Practical Guide to Support Vector Machines,” Technical Report, Dept. of Computer Science and Information Engineering, National Taiwan University, Taipei, 2003.)

Although the filter system is described primarily as filtering out content of a web page, the filter system may be used to filter out content of other types of documents. For example, a company may have a file server that stores documents of the company. Each document may cover multiple topics such as financial, marketing, technical support, and so on. A group of employees may need to review the documents, but the group may not be interested only in financial information, which may be of interest only to auditors. The employees may create a financial filter by selecting financial content of the documents. Eventually, most, if not all, of the financial content of the documents will be filtered out for the employees in the group. A document is any collection of any type or types of content such as text, images, graphics, and so on.

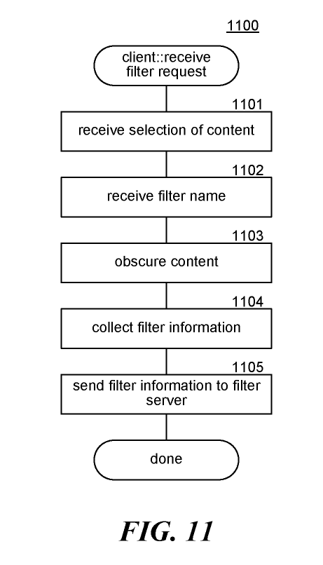

FIG. 11 is a flow diagram that illustrates the processing of a receive filter request component of a filter client in some examples. A receive filter request component 1100 is invoked when a user indicates to specify a filter such as by selecting a filter icon. In block 1101, the component receives a selection of the content for the filter. In block 1102, the component receives the filter name from the user. In block 1103, the component obscures the selected content on the currently displayed document. In block 1104, the component collects the filter information for the filter. The filter information may include the filter name, all the selected content, and all the metadata related to the selected content. Alternatively, rather than including all the selected content or metadata, the filter information may include a feature vector of features derived from the selected content and metadata. In block 1105, the component sends an identifier of the user and the filter information to the filter server and then completes.

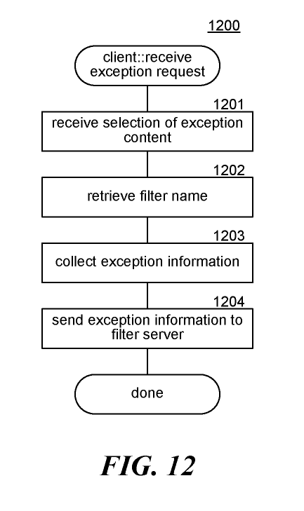

FIG. 12 is a flow diagram that illustrates the processing of a receive exception request component of a filter client in some examples. A receive exception request component 1200 is invoked when a user indicates an exception to a filter such as by selecting an exception icon. In block 1201, the component receives a selection of content for the exception. In block 1202, the component retrieves the filter name for the filter that caused the content to be filtered out. In block 1203, the component collects other exception information that is derived from the selected content and related metadata. In block 1204, the component sends an identifier of the user and the exception information to the filter server and then completes.

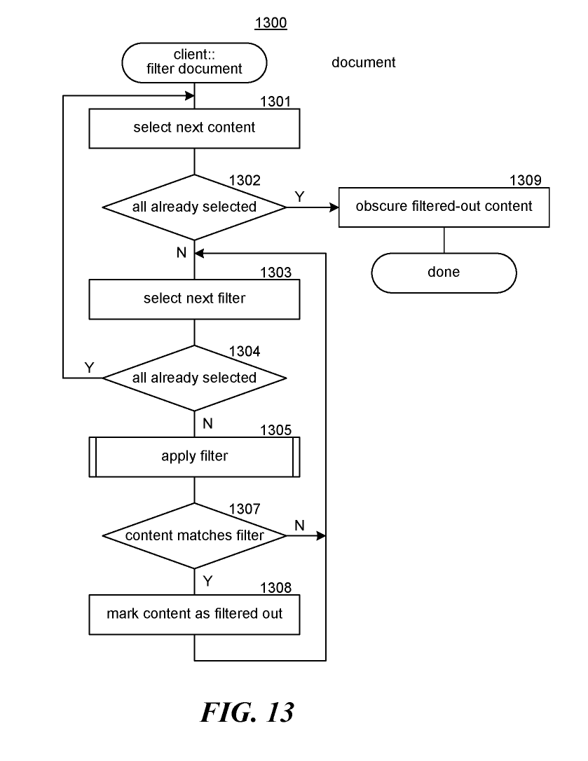

FIG. 13 is a flow diagram that illustrates the processing of a filter document component of a filter client in some examples. A filter document component 1300 is invoked when a document is to be displayed and applies each filter to the content of the document. In block 1301, the component selects the next content of the document. In decision block 1302, if all the content has already been selected, then the component continues at block 1309, else the component continues at block 1303. In block 1303, the component selects the next filter. In decision block 1304, if all the filters have already been selected, then the component loops to block 1301 to select the next content, else the component continues at block 1305. In block 1305, the component invokes an apply filter component to apply the selected filter to select content. In decision block 1307, if the content matches the filter, then the component continues at block 1308, else the component loops to block 1303 to select the next filter. In block 1308, the component marks the selected content as filtered out and then loops to block 1303 to select the next filter. In block 1309, the component obscures any filtered-out content and then returns and the document is displayed with the content obscured.

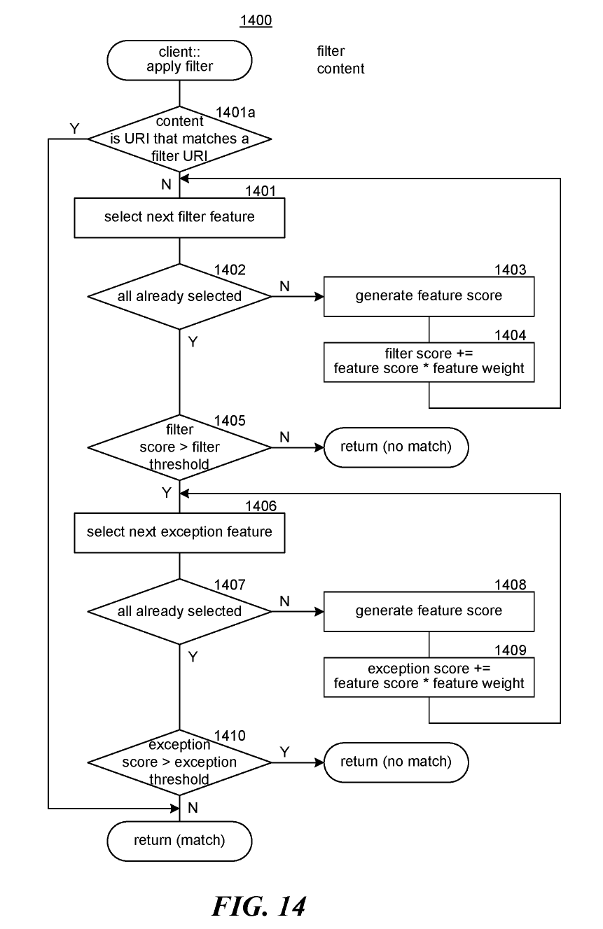

FIG. 14 is a flow diagram that illustrates the processing of an apply filter component of a filter client in some examples. An apply filter component 1400 is invoked for each combination of a filter and content when a document is to be displayed. In block 1401a, if the content is a URI that matches a filter URI of the filter, then the component returns an indication that content matches the filter, else the component continues at block 1401. In blocks 1401-1404, the component generates a filter score based on an aggregate filter feature vector of the filter. In this example, the component generates a weighted feature score for each feature of the feature vector and combines the feature scores to generate a filter score for the content. In block 1401, the component selects the next feature of the filter feature vector. In decision block 1402, if all the features have already been selected, then the component continues at block 1405, else the component continues at block 1403. In block 1403, the component generates a feature score for the content and the selected feature. For example, if the feature is a keyword and the content includes that keyword, then the feature score may be set to one, else the feature score may be set to zero. The feature score may be adjusted based on a weight of that feature. In decision block 1404, the component aggregates a weighted combination of the feature scores into a filter score and then loops to block 1401 to select the next feature. In decision block 1405, if the filter score is greater than the filter threshold, then the content matches the aggregate filter feature vector and the component continues at block 1406 to apply the exceptions, else the component returns an indication that the content does not match the aggregate filter feature vector. In blocks 1406-1409, the component loops, generating an exception score for an exception in much the same way the filter score was generated. In decision block 1410, if the exception score is greater than an exception threshold, then the component returns an indication that the content does not match the filter, else the component returns an indication that the content matches the filter. If the filter has multiple aggregate exception feature vectors, then the component repeats the processing of blocks 1406-1410 for each aggregate feature vector until an aggregate exception feature vector is found with an exception score that is greater than the exception threshold.

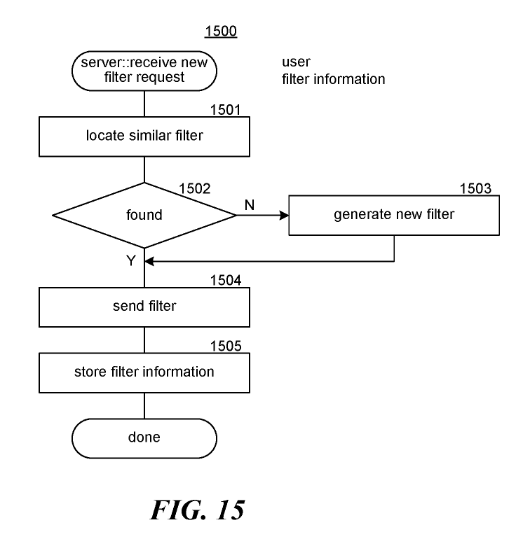

FIG. 15 is a flow diagram that illustrates the processing of a receive new filter request component of a filter server in some examples. A receive new filter request component 1500 is passed an indication of a user and filter information that has been received from a filter client of the user and updates the user filter storage based on the filter information. In block 1501, the component attempts to locate an existing filter that is similar to the filter information. In decision block 1502, if a similar filter is found, then the component continues at block 1504, else the component continues at block 1503. In block 1503, the component generates a new filter based on the filter information. In block 1504, the component send the existing filter or the newly generated filter to the filter client. In block 1505, the component stores the filter information and then completes.

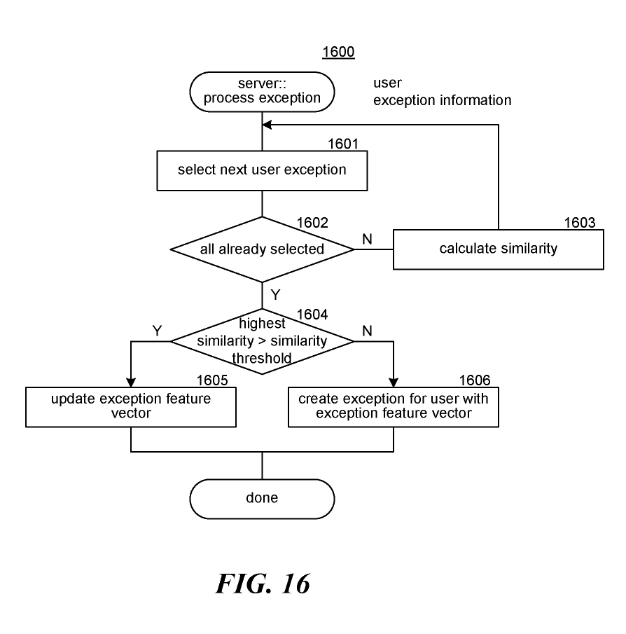

FIG. 16 is a flow diagram that illustrates the processing of a process exception component of a filter server in some examples. A process exception component 1600 is passed an indication of a user and exception information and updates the filter storage based on the exception information. In block 1601, the component selects the next exception feature vector for the user that already exists. In decision block 1602, if all the exception feature vectors have already been selected, then the component continues at block 1604, else the component continues at block 1603. In block 1603, the component calculates a similarity between the passed exception information and the selected exception feature vector and then loops to block 1601 to select the next exception feature vector. In decision block 1604, if the highest similarity of an exception feature vector is greater than a similarity threshold, then the component continues at block 1605, else the component continues at block 1606. In block 1605, the component updates the exception feature vector with the highest similarity based on the exception information and then completes. In block 1606, the component creates an exception feature vector that is based on the exception information and then completes.

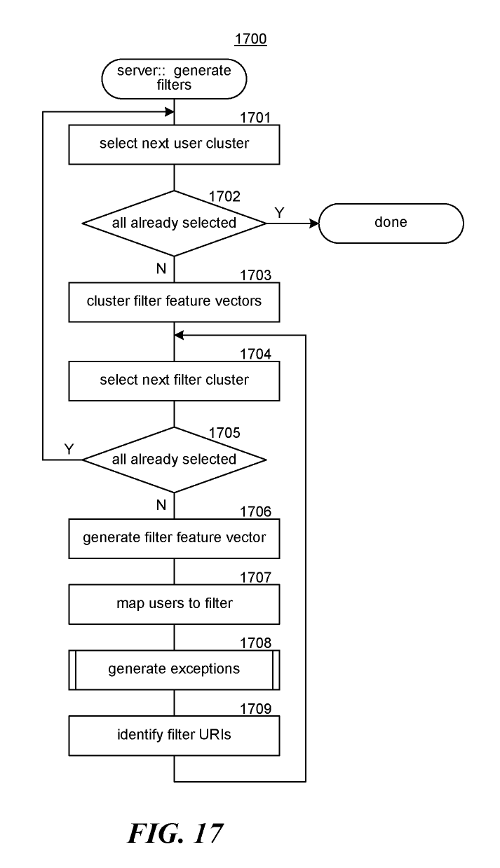

FIG. 17 is a flow diagram that illustrates the processing of a generate filters component of a filter server in some examples. A generate filters component 1700 may be invoked periodically to generate filters for each filter name. The component may initially cluster users based on the similarity of their interaction with the filter system. In block 1701, the component selects the next user cluster. In decision block 1702, if all the user clusters have already been selected, then the component completes, else the component continues at block 1703. In block 1703, the component clusters the filter information associated with the selected user cluster. For example, the component may cluster based on feature vectors representing the filter information. In blocks 1704-1708, the component loops, generating a filter feature vector and an exception feature vector for each filter cluster. In block 1704, the component selects the next filter cluster. In decision block 1705, if all the filter clusters have already been selected, then the component loops to block 1701 to select the next user cluster, else the component continues at block 1706. In block 1706, the component generates a filter feature vector for the selected filter cluster, maps users to the filter feature vector, and updates the filter storage. In block 1707, the component maps the users to the filter for the filter cluster. In block 1708, the component invokes a generate exceptions component to generate clusters of exception feature vectors for the selected filter cluster. In block 1709, the component identifies filter URIs for the filter and then loops to block 1704 to select the next filter cluster. For example, the component analyzes the sematic map storage and the web content storage and the multimedia content storage to identify content that is semantically related to content that is filtered out by the filter.

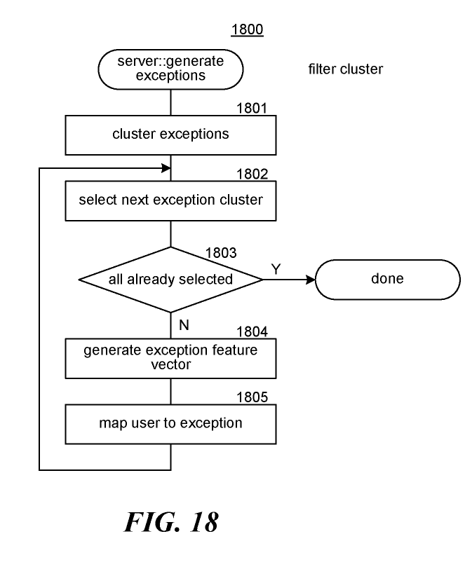

FIG. 18 is a flow diagram that illustrates the processing of a generate exceptions component of a filter server in some examples. A generate exceptions component 1800 is invoked passing exception information associated with filter information used to generate a filter feature vector and generates exception feature vectors for a filter cluster. In block 1801, the component clusters the exception information associated with the filter cluster. In block 1802, the component selects the next exception cluster. In decision block 1803, if all the exception clusters have already been selected, then the component returns, else the component continues at block 1804. In block 1804, the component generates an exception feature vector for the selected exception cluster. In block 1805, the component maps a subset of users that map to the filter cluster to the exception feature vector and updates the filter storage and then loops to block 1802 to select the next exception cluster.

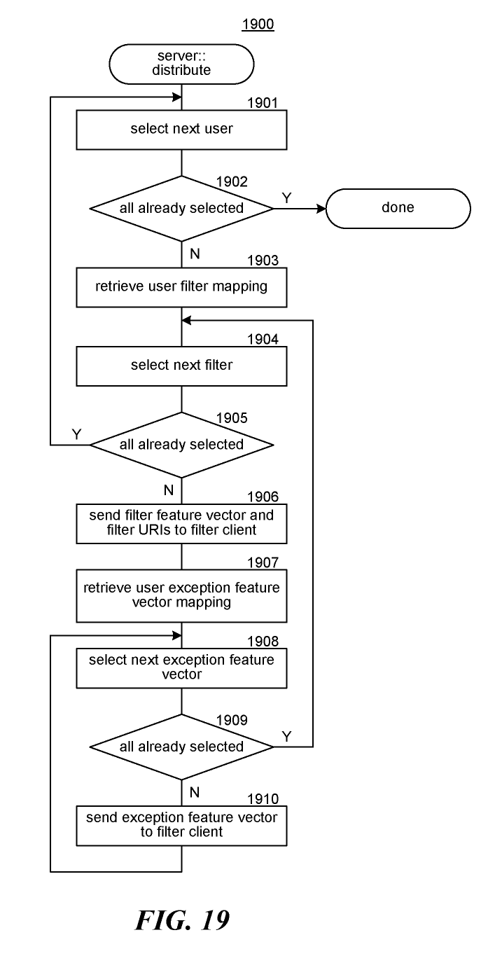

FIG. 19 is a flow diagram that illustrates the processing of a distribute component of a filter server in some examples. A distribute component 1900 is invoked periodically to distribute updated filters to users. For example, the component may distribute filters as they are updated, periodically, or in response to a request from a filter client. In block 1901, the component selects the next user. In decision block 1902, if all the users have already been selected, then the component completes, else the component continues at block 1903. In block 1903, the component retrieves the mapping of the users to the filters. In block 1904, the component selects the next filter for the selected user. In decision block 1905, if all the aggregate filters have already been selected, then the component loops to block 1901 to select the next user, else the component continues at block 1906. In block 1906, the component sends the filter feature vector and the filter URIs for the selected filter to the filter client of the user. In block 1907, the component retrieves a mapping of the selected user to exceptions feature vectors for the filter. In block 1908, the component selects the next exception feature vector. In decision block 1909, if all the exception feature vectors have already been selected, then the component loops to block 1904 to select the next filter, else the component continues at block 1910. In block 1910, the component sends the exception feature vector to the filter client of the user and then loops to block 1908 to select the next exception feature vector.

The following paragraphs describe various examples of aspects of the filter system. An implementation of a filter system may employ any combination of the examples.

In some examples, a method performed by a device for filtering content of a web page prior to displaying the web page is provided. The method comprises one or more of receiving, from a first user via a first device, a selection of at least one portion of content associated with a displayed first web page; sending, to a filter server, first filter information that includes content information derived from the selected content; receiving, from the filter server, a filter, the filter generated based at least on second filter information that is similar to the first filter information, the second filter information corresponding to filter information received from a plurality of second devices associated with a plurality of second users, respectively; receiving a second web page; applying the received filter to content associated with the second web page; and causing a filtered version of the second web page to be displayed, the filtered version of the second web page obscuring those portions of the content associated with the second web page that match the filter. In some examples, the method further comprises after receiving the selection of the content of the first web page, displaying the first web page with the selected content obscured. In some examples, the method further comprises receiving from the first user a filter name and wherein the filter name was previously provided by the first user for previously selected content so that the filter server can use the filter name as an indication that the selected content should match the filter with the filter name. In some examples, the filter information includes metadata information relating to the content. In some examples, the metadata information includes one or more of a resource identifier for the web page, a uniform resource identifier of the content, a date associated with the content, and an identifier of an author of the content. In some examples, the content information includes features derived from the content. In some examples, the features include keywords derived from the content. In some examples, the features include characteristics of an image of the content. In some examples, the method further comprises one or more of receiving from the first user a selection of content of a web page that matches the filter; and sending to the filter server exception information derived from the selected content that matches the filter. In some examples, the method further comprises one or more of receiving from the first user a selection of content of a web page that matches the filter; storing exception information derived from the selected content that matches the filter; and using the exception information to except content that would otherwise match the filter. In some examples, the method further comprises receiving from the filter server a list of available filters and receiving from the first user a selection of an available filter for applying to content of a web page. In some examples, the filter includes one or more filter content identifiers that uniquely identify content to be filtered out.

In some examples, a device for generating filters for documents is provided. The device comprises at least one processor; and a storage medium storing instructions that, based on execution by the at least one processor, configure the at least one processor to perform one or more of receive, from a first user, first filter information that includes first content information, the first content information derived from first content that was selected by the first user and is associated with a first document; receive, from a second user, second filter information that is similar to the first filter information and includes second content information, the second content information derived from second content that was selected by the second user and is associated with a second document; generate a filter based on an aggregation of at least the first filter information and the second filter information, the generated filter configured to identify any content that is similar to the first and second contents; and distribute the filter to at least a third user to enable the third user to apply the filter to content included in at least a third document. In some examples, the first content information and the second content information include keywords derived from the first content and the second content, respectively, and wherein the instructions that generate include instructions that select the most common keywords of the first content information and the second content information as part of the filter. In some examples, the instructions further include instructions that identify content that is semantically related to filter information and that augment the filter with unique content identifiers of the identified content. In some examples, the instructions further include instructions that cluster the filter information based on the content information and generate a filter for each cluster based on the content information of the cluster. In some examples, the instructions further include instructions that receive exception information that includes the filter name and content information and that update the filter based on the exception information. In some examples, the instructions further include instructions that receive additional filter information with the same filter name and additional content information and update the filter based on the additional content information.

In some examples, a device adapted to filter content of a document is provided. The device comprises at least one processor; and a storage medium storing instructions that based on execution by the at least one processor, configure the at least one processor to perform one or more of receive a selection of content of a first document, wherein content of documents that is similar to the selected content is to be obscured when the documents are displayed; send, to a filter server, filter information that includes content information derived from the selected content; and receive, from the filter server, a filter generated from filter information sent from the device and from other devices; obscure content of a second document that matches the filter. In some examples, the instructions further include instructions that receive a selection of content of a third document that should match the filter and send to the filter server information that includes content information derived from the selected content of the third document and an indication that the selected content of the third document should match the filter.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by a device for filtering content of a web page prior to displaying the web page, the method comprising:
receiving, from a first user via a first device, a selection of at least one portion of content associated with a displayed first web page;
sending, to a filter server, first filter information that includes content information derived from the selected content;
receiving, from the filter server, a filter, the filter generated based at least on second filter information that is similar to the first filter information, the second filter information corresponding to filter information received from a plurality of second devices associated with a plurality of second users, respectively;
receiving a second web page;
applying the received filter to content associated with the second web page; and
causing a filtered version of the second web page to be displayed, the filtered version of the second web page obscuring those portions of the content associated with the second web page that match the filter.

2. The method of claim 1 further comprising after receiving the selection of the content of the first web page, displaying the first web page with the selected content obscured.

3. The method of claim 1 further comprising receiving from the first user a filter name and wherein the filter name was previously provided by the first user for previously selected content so that the filter server can use the filter name as an indication that the selected content should match the filter with the filter name.

4. The method of claim 1 wherein the filter information includes metadata information relating to the content.

5. The method of claim 4 wherein the metadata information includes one or more of a resource identifier for the web page, a uniform resource identifier of the content, a date associated with the content, and an identifier of an author of the content.

6. The method of claim 1 wherein the content information includes features derived from the content.

7. The method of claim 6 wherein the features include keywords derived from the content.

8. The method of claim 6 wherein the features include characteristics of an image of the content.

9. The method of claim 1 further comprising:
receiving from the first user a selection of content of a web page that matches the filter; and
sending to the filter server exception information derived from the selected content that matches the filter.

10. The method of claim 1 further comprising:
receiving from the first user a selection of content of a web page that matches the filter; storing exception information derived from the selected content that matches the filter; and
using the exception information to except content that would otherwise match the filter.

11. The method of claim 1 further comprising receiving from the filter server a list of available filters and receiving from the first user a selection of an available filter for applying to content of a web page.

12. The method of claim 1 wherein the filter includes one or more filter content identifiers that uniquely identify content to be filtered out.

13. A device for generating filters for documents, the device comprising:
at least one processor; and
a storage medium storing instructions that, based on execution by the at least one processor, configure the at least one processor to:
receive, from a first user, first filter information that includes first content information, the first content information derived from first content that was selected by the first user and is associated with a first document;
receive, from a second user, second filter information that is similar to the first filter information and includes second content information, the second content information derived from second content that was selected by the second user and is associated with a second document;
generate a filter based on an aggregation of at least the first filter information and the second filter information, the generated filter configured to identify any content that is similar to the first and second contents; and
distribute the filter to at least a third user to enable the third user to apply the filter to content included in at least a third document.

14. The device of claim 13 wherein the first content information and the second content information include keywords derived from the first content and the second content, respectively, and wherein the instructions that generate include instructions that select the most common keywords of the first content information and the second content information as part of the filter.

15. The device of claim 13 wherein the instructions further include instructions that identify content that is semantically related to filter information and that augment the filter with unique content identifiers of the identified content.

16. The device of claim 12 wherein the instructions further include instructions that cluster the filter information based on the content information and generate a filter for each cluster based on the content information of the cluster.

17. The device of claim 12 wherein the instructions further include instructions that receive exception information that includes the filter name and content information and that update the filter based on the exception information.

18. The device of claim 12 wherein the instructions further include instructions that receive additional filter information with the same filter name and additional content information and update the filter based on the additional content information.

19. A first device comprising:
at least one processor; and
a storage medium storing instructions that, based on execution by the at least one processor, configure the at least one processor to:
receive a selection of first content associated with a first document;
send, to a filter server, first filter information that includes first content information derived from the selected first content;
receive, from the filter server, a filter generated at least based on the first filter information sent to the filter server from the first device and from second filter information sent to the filter server from at least one second device, the second filter information including second content information derived from second content that was selected from and associated with a second document, the first filter information being similar to the second filter information; and
obscure those portions of a third document that match the filter.

20. The device of claim 19 wherein the instructions further include instructions that receive a selection of content of a fourth document that should match the filter and send to the filter server information that includes content information derived from the selected content of the fourth document and an indication that the selected content of the third document should match the filter.
